(19) United States
(12) Patent Application Publication
(10) Pub. No.: US 2004/0029930 A1
(43) Pub. Date: Feb. 12, 2004

(54) Fungicidal mixtures based on amide compounds

(76) Inventors: Karl Eicken, Wachenheim (DE); Arne Ptock, Ludwigshafen (DE); Eberhard Ammermann, Heppenheim (DE); Reinhard Stierl, Mutterstadt (DE); Gisela Lorenz, Hambach (DE); Siegfried Strathmann, Limburgerhoff (DE); Maria Scherer, Landau (DE); Klaus Schelberger, Gonnheim (DE); Manfred Hampel, Neustadt (DE)

Correspondence Address: KEIL & WEINKAUF, 1350 CONNECTICUT AVENUE, N.W., WASHINGTON, DC, 20036, US

(21) Appl. No.: 10/450,129

(22) PCT Filed: Dec. 13, 2001
(86) PCT No.: PCT/EP01/14651

(30) Foreign Application Priority Data
Dec. 18, 2000 (DE) 10063047.2

(51) Int. Cl. A01N 43/40; A01N 43/50

(52) U.S. Cl. 514/354; 514/398

(57) ABSTRACT

Fungicidal mixtures, comprising

A) amide compounds of the formula I

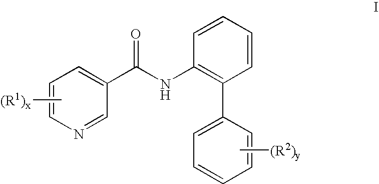

in which

R¹, R² are identical or different and are halogen, nitro, cyano, C₁-C₈-alkyl, C₂-C₈-alkenyl, C₂-C₈-alkynyl, C₁-C₈-haloalkyl, C₂-C₈-haloalkenyl, C₂-C₈-haloalkynyl, C₁-C₈-alkoxy, C₁-C₈-haloalkoxy, C₁-C₈-haloalkylthio, C₁-C₈-alkylsulfinyl or C₁-C₈-alkylsulfonyl;

x is from 1 to 4 and y is from 1 to 5; and

B) imidazole derivatives of the formula II

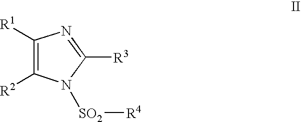

in which R¹ and R² are halogen and phenyl which may be substituted by halogen or alkyl, or R¹ and R² together with the bridging C═C double bond form a 3,4-difluoromethylenedioxyphenyl group;

R³ is cyano or halogen and R⁴ is dialkylamino or isoxazol-4-yl which may carry two alkyl radicals,

in a synergistically effective amount, methods for controlling harmful fungi using mixtures of the compounds I and II and the use of the compounds I and the compounds II for preparing such mixtures are described.

The present invention relates to fungicidal mixtures, comprising

A) amide compounds of the formula I

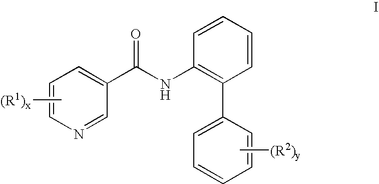

in which

R¹, R² are identical or different and are halogen, nitro, cyano, C₁-C₈-alkyl, C₂-C₈-alkenyl, C₂-C₈-alkyny, C₁-C₈-haloalkyl, C₂-C₈-haloalkenyl, C₂-C₈-haloalkynyl, C₁-C₈-alkoxy, C₁-C₈-haloalkoxy, C₁-C₈-haloalkylthio, C₁-C₈-alkylsulfinyl or C₁-C₈-alkylsulfonyl;

x is 1, 2, 3 or 4;

y is 1, 2, 3, 4 or 5; and

B) imidazole derivatives of the formula II

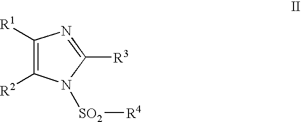

in which R¹ and R² are halogen or phenyl which may be substituted by halogen or C₁-C₄-alkyl, or

R¹ and R² together with the bridging C═C double bond form a 3,4-difluoromethylenedioxyphenyl group;

R³ is cyano or halogen, and

R⁴ is di-(C₁-C₄-alkyl)amino or isoxazol-4-yl which may carry two C₁-C₄-alkyl radicals,

in a synergistically effective amount.

Moreover, the invention relates to methods for controlling harmful fungi using mixtures of the compounds I and II, and to the use of the compounds I and the compounds II for preparing such mixtures.

The compounds of the formula I, their preparation and their action against harmful fungi have been disclosed in the literature (WO-A 93/15046; WO-A 96/01256 and WO-A 96/01258).

The imidazole derivatives of the formula II, their preparation and their action against harmful fungi have also been disclosed (EP-A 298 196, WO-A 97/06171).

It is an object of the present invention to provide mixtures which have improved activity against harmful fungi combined with a reduced total amount of active compounds applied (synergistic mixtures), with a view to reducing the application rates and improving the activity spectrum of known compounds I and II.

We have found that this object is achieved by the mixtures defined at the outset. Moreover, we have found that applying the compounds I and the compounds II simultaneously, i.e. together or separately, or applying the compounds I and the compounds II in succession provides better control of harmful fungi than is possible with the individual compounds alone.

The mixtures according to the invention act synergistically and they are therefore especially suitable for controlling harmful fungi, in particular powdery mildew fungi in cereals, vegetables, fruits, ornamental plants and grapevines.

The formula I represents in particular compounds in which R¹ is located in the 2-position and R² is located in the 4-position (formula I.1):

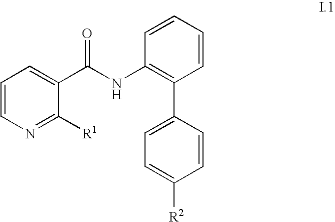

Particular preference is given to compounds of the formula I.1 in which the combination of the substituents corresponds to one line of Table I below:

| No. | R¹ | R² |
|---|---|---|
| I-1 | F | F |
| I-2 | F | Cl |
| I-3 | F | Br |
| I-4 | Cl | F |
| I-5 | Cl | Cl |
| I-6 | Cl | Br |
| I-7 | CF₃ | F |
| I-8 | CF₃ | Cl |
| I-9 | CF₃ | Br |
| I-10 | CF₂H | F |
| I-11 | CF₂H | Cl |
| I-12 | CF₂H | Br |
| I-13 | CH₃ | F |
| I-14 | CH₃ | Cl |
| I-15 | CH₃ | Br |
| I-16 | OCH₃ | F |
| I-17 | OCH₃ | Cl |
| I-18 | OCH₃ | Br |
| I-19 | SCH₃ | F |
| I-20 | SCH₃ | Cl |
| I-21 | SCH₃ | Br |
| I-22 | S(O)CH₃ | F |
| I-23 | S(O)CH₃ | Cl |
| I-24 | S(O)CH₃ | Br |
| I-25 | SO₂CH₃ | F |
| I-26 | SO₂CH₃ | Cl |
| I-27 | SO₂CH₃ | Br |

Particular preference is given to the compounds I.1 in which R¹ is CF₃ or halogen and R² is halogen.

Preference is given to compounds of the formula II in which R¹ is halogen, in particular chlorine, and R² is tolyl, in particular p-tolyl.

Preference is also given to compounds of the formula II in which R⁴ is dimethylamino.

In addition, particular preference is given to the compound of the formula IIa (common name: cyazofamid). This compound is disclosed in EP-A 298 196.

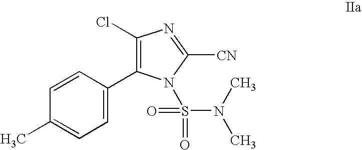

Preference is furthermore given to compounds of the formula II in which R¹ and R² together with the bridging C═C double bond form a 3,4-difluoromethylenedioxyphenyl group.

In addition, preference is given to compounds of the formula II in which R⁴ is 3,5-dimethylisoxazol-4-yl.

Particular preference is given to the compounds of the formula IIb in which X is halogen.

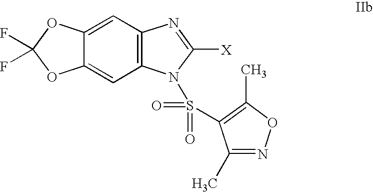

Halogen denotes fluorine, chlorine, bromine and iodine. Particular preference is given to compounds of the formula IIb in which X is bromine (IIb.1) or chlorine (IIb.2).

Owing to the basic character of their nitrogen atoms, the compounds II are capable of forming salts or adducts with inorganic or organic acids or with metal ions.

Examples of inorganic acids are hydrohalic acids such as hydrofluoric acid, hydrochloric acid, hydrobromic acid and hydriodic acid, and carbonic acid, sulfuric acid, phosphoric acid and nitric acid.

Suitable organic acids are, for example, formic acid and alkanoic acids, such as acetic acid, trifluoroacetic acid, trichloroacetic acid and propionic acid, and also glycolic acid, thiocyanic acid, lactic acid, succinic acid, citric acid, benzoic acid, cinnamic acid, oxalic acid, alkylsulfonic acids (sulfonic acids having straight-chain or branched alkyl radicals of 1 to 20 carbon atoms), arylsulfonic acids or aryldisulfonic acids (aromatic radicals, such as phenyl and naphthyl, which carry one or two sulfo groups), alkylphosphonic acids (phosphonic acids having straight-chain or branched alkyl radicals of 1 to 20 carbon atoms), arylphosphonic acids or aryldiphosphonic acids (aromatic radicals, such as phenyl and naphthyl, which carry one or two phosphonic acid radicals), it being possible for the alkyl or aryl radicals to carry further substituents, e.g. p-toluenesulfonic acid, salicylic acid, p-aminosalicylic acid, 2-phenoxybenzoic acid, 2-acetoxybenzoic acid, etc.

Suitable metal ions are, in particular, the ions of the elements of the first to eighth subgroup, in particular chromium, manganese, iron, cobalt, nickel, copper, zinc and furthermore of the second main group, in particular calcium and magnesium, and of the third and fourth main group, in particular aluminum, tin and lead. The metals can be present in the various valencies which they can assume.

When preparing the mixtures, it is preferred to employ the pure active ingredients I and II, to which further active ingredients against harmful fungi or other pests, such as insects, arachnids or nematodes, or else herbicidal or growth-regulating active ingredients or fertilizers can be admixed.

The mixtures of the compounds I and II, or the compounds I and II used simultaneously, jointly or separately, exhibit outstanding activity against a wide range of phytopathogenic fungi, in particular from the classes of the Ascomycetes, Basidiomycetes, Phycomycetes and Deuteromycetes. Some of them act systemically and can therefore also be employed as foliar- and soil-acting fungicides.

They are especially important for controlling a large number of fungi in a variety of crop plants, such as cotton, vegetable species (e.g. cucumbers, beans, tomatoes, potatoes and cucurbits), barley, grass, oats, bananas, coffee, maize, fruit species, rice, rye, soya, grapevine, wheat, ornamentals, sugar cane, and a variety of seeds.

They are particularly suitable for controlling the following phytopathogenic fungi: Blumeria graminis (powdery mildew) in cereals, Erysiphe cichoracearum and Sphaerotheca fuliginea in cucurbits, Podosphaera leucotricha in apples, Uncinula necator in grapevines, Puccinia species in cereals, Rhizoctonia species in cotton, rice and lawns, Ustilago species in cereals and sugar cane, Venturia inaequalis (scab) in apples, Helminthosporium species in cereals, Septoria nodorum in wheat, Botrytis cinerea (gray mold) in strawberries, vegetables, ornamentals and grapevines, Cercospora arachidicola in groundnuts, Pseudocercosporella herpotrichoides in wheat and barley, Pyricularia oryzae in rice, Phytophthora infestans in potatoes and tomatoes, Plasmopara viticola in grapevines, Pseudoperonospora species in hops and cucumbers, Alternaria species in vegetables and fruit, Mycosphaerella species in bananas and Fusarium and Verticillium species.

Moreover, they can be used for the protection-of materials (e.g. the protection of wood), for example against Paecilomyces variotii.

The compounds I and II can be applied simultaneously, either together or separately, or in succession, the sequence, in the case of separate application, generally not having any effect on the result of the control measures.

The compounds I and II are usually employed in a weight ratio of from 100:1 to 1:20, in particular from 80:1 to 1:1.

Depending on the kind of effect desired, the application rates of the mixtures according to the invention are, in particular in agricultural crop areas, from 0.01 to 8 kg/ha, preferably 0.1 to 5 kg/ha, in particular 0.1 to 3.0 kg/ha.

The application rates of the compounds I are from 0.01 to 1 kg/ha, preferably 0.05 to 0.5 kg/ha, in particular 0.05 to 0.3 kg/ha.

Correspondingly, in the case of the compounds II, the application rates are from 0.01 to 1 kg/ha, preferably 0.02 to 0.5 kg/ha, in particular 0.05 to 0.3 kg/ha.

For seed treatment, the application rates of the mixture are generally from 0.001 to 250 g/kg of seed, preferably 0.01 to 100 g/kg, in particular 0.01 to 50 g/kg.

If phytopathogenic harmful fungi are to be controlled, the separate or joint application of the compounds I and II or of the mixtures of the compounds I and II is effected by spraying or dusting the seeds, the plants or the soils before or after sowing of the plants, or before or after plant emergence.

The fungicidal synergistic mixtures according to the invention, or the compounds I and II, can be formulated for example in the form of ready-to-spray solutions, powders and suspensions or in the form of highly concentrated aqueous, oily or other suspensions, dispersions, emulsions, oil dispersions, pastes, dusts, materials for broadcasting or granules, and applied by spraying, atomizing, dusting, broadcasting or watering. The use form depends on the intended purpose; in any case, it should ensure as fine and uniform as possible a distribution of the mixture according to the invention.

The formulations are prepared in a manner known per se, e.g. by adding solvents and/or carriers. The formulations are usually admixed with inert additives such as emulsifiers or dispersants.

Suitable surfactants are the alkali metal salts, alkaline earth metal salts and ammonium salts of aromatic sulfonic acids, e.g. ligno-, phenol-, naphthalene- and dibutylnaphthalenesulfonic acid, and of fatty acids, alkyl- and alkylarylsulfonates, alkyl, lauryl ether and fatty alcohol sulfates, and salts of sulfated hexa-, hepta- and octadecanols, or of fatty alcohol glycol ethers, condensates of sulfonated naphthalene and its derivatives with formaldehyde, condensates of naphthalene or of the naphthalenesulfonic acids with phenol and formaldehyde, polyoxyethylene octylphenol ether, ethoxylated isooctyl-, octyl- or nonylphenol, alkylphenol polyglycol ethers, tributylphenyl polyglycol ethers, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignosulfite waste liquors or methylcellulose.

Powders, materials for broadcasting and dusts can be prepared by mixing or jointly grinding the compounds I or II, or the mixture of the compounds I and II, with a solid carrier.

Granules (e.g. coated granules, impregnated granules or homogeneous granules) are usually prepared by binding the active ingredient, or active ingredients, to a solid carrier.

Fillers or solid carriers are, for example, mineral earths, such as silicas, silica gels, silicates, talc, kaolin, limestone, lime, chalk, bole, loess, clay, dolomite, diatomaceous earth, calcium sulfate, magnesium sulfate, magnesium oxide, ground synthetic materials and fertilizers, such as ammonium sulfate, ammonium phosphate, ammonium nitrate, ureas, and products of vegetable origin, such as cereal meal, tree bark meal, wood meal and nutshell meal, cellulose powders or other solid carriers.

The formulations generally comprise from 0.1 to 95% by weight, preferably 0.5 to 90% by weight, of one of the compounds I or II or of the mixture of the compounds I and II. The active ingredients are employed in a purity of from 90% to 100%, preferably 95% to 100% (according to NMR spectrum or HPLC).

The compounds I and II, the mixtures, or the corresponding formulations, are applied by treating the harmful fungi, their habitat, or the plants, seeds, soils, areas, materials or spaces to be kept free from them with a fungicidally effective amount of the mixture, or of the compounds I and II in the case of separate application.

Application can be effected before or after infection by the harmful fungi.

### USE EXAMPLE

The synergistic activity of the mixtures according to the invention can be demonstrated by the following experiments:

The active ingredients, separately or together, are formulated as a 10% emulsion in a mixture of 63% by weight of cyclohexanone and 27% by weight of emulsifier, and diluted with water to the desired concentration.

Evaluation is carried out by determining the infected leaf areas in percent. These percentages are converted into efficacies. The efficacy (W) is calculated as follows using Abbot's formula:

W=(1−α)·100/β

α corresponds to the fungal infection of the treated plants in % and

β corresponds to the fungal infection of the untreated (control) plants in %

An efficacy of 0 means that the infection level of the treated plants corresponds to that of the untreated control plants; an efficacy of 100 means that the treated plants were not infected.

The expected efficacies of the mixtures of the active ingredients were determined using Colby's formula [R. S. Colby, Weeds 15, 20-22 (1967)] and compared with the observed efficacies.

E=x+y−x·y/100 Colby's formula

E expected efficacy, expressed in % of the untreated control, when using the mixture of the active ingredients A and B at the concentrations a and b

X efficacy, expressed in % of the untreated control, when using active ingredient A at a concentration of a

Y efficacy, expressed in % of the untreated control, when using active ingredient B at a concentration of b

### USE EXAMPLE

### Activity Against Peronospora in Grape Vines Caused by Plasmmopara viticola

Leaves of potted vines of the cultivar “Müller-Thurgau” were sprayed to runoff point with an aqueous preparation of active ingredient which had been prepared using a stock solution comprising 10% of active ingredient, 85% of cyclohexanone and 5% of emulsifier. The next day, the undersides of the leaves were inoculated with an aqueous zoospore suspension of Plasmopara viticola. The vines were then placed firstly for 48 hours in a water-vapor-saturated chamber at 24° C. and then for 5 days in a greenhouse at 20-30° C. After this period of time, the plants were again placed in a moist chamber for 16 hours to accelerate the sporangiophore eruption. The extent to which the undersides of the leaves had been infected was then determined visually.

TABLE A
Individual active ingredients

| | | Concentration of | |
|---|---|---|---|
| | | active ingredient | Efficacy in % of |
| | | in the spray | the untreated |
| Example | Active ingredient | liquor [ppm] | control |
| 1 | Control | (94% infection) | 0 |
| | (untreated) | | |
| 2 | I-4 | 160 | 4 |
| | | 80 | 0 |
| | | 16 | 0 |
| 3 | I-5 | 160 | 0 |
| | | 80 | 0 |
| | | 16 | 0 |
| 4 | cyazofamid | 16 | 89 |
| | IIa | 8 | 84 |
| | | 4 | 79 |
| | | 1 | 73 |
| 5 | IIb.1 | 16 | 84 |
| | | 8 | 79 |
| | | 4 | 73 |
| | | 1 | 68 |

TABLE B
Combinations according to the invention

| | Mixture of active | | |
|---|---|---|---|
| | ingredients | | |
| | concentration mixing | Observed | Calculated |
| Example | ratio | efficacy | efficacy*) |
| 6 | I-4 + IIa | 100 | 84 |
| | 80 + 8 ppm | | |
| | 10:1 | | |
| 7 | I-4 + IIa | 100 | 85 |
| | 160 + 8 ppm | | |
| | 20:1 | | |
| 8 | I-4 + IIa | 100 | 79 |
| | 80 + 4 ppm | | |
| | 20:1 | | |
| 9 | I-4 + IIa | 100 | 80 |
| | 160 + 4 ppm | | |
| | 40:1 | | |
| 10 | I-4 + IIa | 100 | 89 |
| | 80 + 16 ppm | | |
| | 5:1 | | |
| 11 | I-4 + IIa | 100 | 73 |
| | 80 + 1 ppm | | |
| | 80:1 | | |
| 12 | I-4 + IIa | 100 | 84 |
| | 16 + 8 ppm | | |
| | 2:1 | | |
| 13 | I-4 + IIa | 100 | 79 |
| | 16 + 4 ppm | | |
| | 4:1 | | |
| 14 | I-4 + IIa | 93 | 73 |
| | 16 + 1 ppm | | |
| | 16:1 | | |
| 15 | I-5 + IIa | 100 | 84 |
| | 80 + 8 ppm | | |
| | 10:1 | | |
| 16 | I-5 + IIa | 100 | 84 |
| | 160 + 8 ppm | | |
| | 20:1 | | |
| 17 | I-5 + IIa | 100 | 79 |
| | 80 + 4 ppm | | |
| | 20:1 | | |
| 18 | I-5 + IIa | 100 | 79 |
| | 160 + 4 ppm | | |
| | 40:1 | | |
| 19 | I-5 + IIa | 100 | 89 |
| | 80 + 16 ppm | | |
| | 5:1 | | |
| 20 | I-5 + IIa | 100 | 73 |
| | 80 + 1 ppm | | |
| | 80:1 | | |
| 21 | I-5 + IIa | 100 | 84 |
| | 16 + 8 ppm | | |
| | 2:1 | | |
| 22 | I-5 + IIa | 100 | 79 |
| | 16 + 4 ppm | | |
| | 4:1 | | |
| 23 | I-5 + IIa | 93 | 73 |
| | 16 + 1 ppm | | |
| | 16:1 | | |
| 24 | I-4 + IIb.1 | 89 | 79 |
| | 80 + 8 ppm | | |
| | 10:1 | | |
| 25 | I-4 + IIb.1 | 89 | 80 |
| | 160 + 8 ppm | | |
| | 20:1 | | |
| 26 | I-4 + IIb.1 | 84 | 73 |
| | 80 + 4 ppm | | |
| | 20:1 | | |
| 27 | I-4 + IIb.1 | 95 | 74 |
| | 160 + 4 ppm | | |
| | 40:1 | | |
| 28 | I-4 + IIb.1 | 89 | 79 |
| | 16 + 8 ppm | | |
| | 2:1 | | |
| 29 | I-4 + IIb.1 | 99 | 73 |
| | 16 + 4 ppm | | |
| | 4:1 | | |
| 30 | I-5 + IIb.1 | 89 | 79 |
| | 80 + 8 ppm | | |
| | 10:1 | | |
| 31 | I-5 + IIb.1 | 89 | 79 |
| | 160 + 8 ppm | | |
| | 20:1 | | |
| 32 | I-5 + IIb.1 | 84 | 73 |
| | 80 + 4 ppm | | |
| | 20:1 | | |

*) calculated using Colby's formula

The test results show that, for all mixing ratios, the observed efficacy is higher than that calculated beforehand using Colby's formula.

We claim:

1. A fungicidal mixture, comprising
A) amide compounds of the formula I 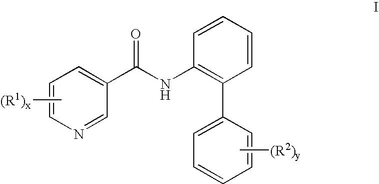
in which
R¹, R² are identical or different and are halogen, nitro, cyano, C₁-C₈-alkyl, C₂-C₈-alkenyl, C₂-C₈-alkynyl, C₁-C₈-haloalkyl, C₂-C₈-haloalkenyl, C₂-C₈-haloalkynyl, C₁-C₈-alkoxy, C₁-C₈-haloalkoxy, C₁-C₈-haloalkylthio, C₁-C₈-alkylsulfinyl or C₁-C₈-alkylsulfonyl;
x is 1, 2, 3 or 4;
y is 1, 2, 3, 4 or 5; and
B) imidazole derivatives of the formula II 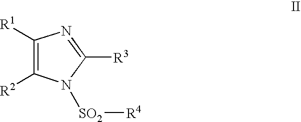
in which R¹ and R² are halogen or phenyl which may be substituted by halogen or C₁-C₄-alkyl, or
R¹ and R² together with the bridging C═C double bond form a 3,4-difluoromethylenedioxyphenyl group;
R³ is cyano or halogen, and
R⁴ is di-(C₁-C₄-alkyl)amino or isoxazol-4-yl which may carry two C₁-C₄-alkyl radicals,
in a synergistically effective amount.

2. A fungicidal mixture as claimed in claim 1, where the imidazole derivative II corresponds to the formula IIa

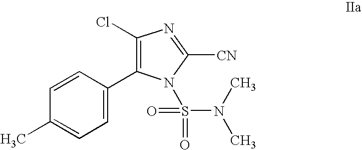

3. A fungicidal mixture as claimed in claim 1, where the imidazole derivative II corresponds to the formula IIb 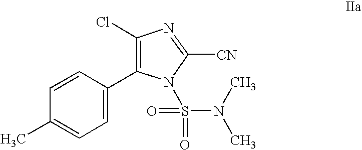
where X is chlorine or bromine.

4. A fungicidal mixture as claimed in any of claims 1 to 3, wherein the weight ratio of the amide compounds I to the imidazole derivatives of the formula II is from 100:1 to 1:20.

5. A method for controlling harmful fungi, which comprises treating the fungi, their habitat or the plants, seeds, soils, areas, materials or spaces to be kept free from them with amide compounds of the formula I as set forth in claim 1 and imidazole derivatives of the formula II as set forth in any of claims 1 to 3.

6. A method as claimed in claim 5, wherein the amide compounds of the formula I as set forth in claim 1 and the imidazole derivatives of the formula II as set forth in any of claims 1 to 3 are applied simultaneously, that is either jointly or separately, or in succession.

7. A method as claimed in claim 5 or 6, wherein the amide compound of the formula I as set forth in claim 1 is applied in an amount of from 0.01 to 2.5 kg/ha.

8. A process as claimed in any of claims 5 to 7, wherein the imidazole derivatives of the formula II as set forth in any of claims 1 to 3 are applied in an amount of from 0.01 to 10 kg/ha.

9. The use of the amide compounds of the formula I as set forth in any of claims 1 to 3 for preparing a fungicidally effective synergistic mixture as claimed in.claim 1.

10. The use of the imidazole derivatives of the formula II as set forth in any of claims 1 to 3 for preparing a fungicidally effective synergistic mixture as claimed in claim 1.
